(19) United States
(12) Patent Application Publication
(10) Pub. No.: US 2006/0110648 A1
(43) Pub. Date: May 25, 2006

(54) Separator for fuel cell system, and method for preparing the same

(76) Inventors: Jong-Ki Lee, Suwon-si (KR); Ho-Jin Kweon, Suwon-si (KR); Jun-Won Suh, Suwon-si (KR)

Correspondence Address: CHRISTIE, PARKER & HALE, LLP, PO BOX 7068, PASADENA, CA, 91109-7068, US

(21) Appl. No.: 11/285,802

(22) Filed: Nov. 23, 2005

(30) Foreign Application Priority Data
Nov. 25, 2004 (KR) 10-2004-0097381

(51) Int. Cl. H01M 8/02; B05D 5/12; B32B 15/04

(52) U.S. Cl. 429/38; 427/115; 428/586; 428/595; 428/627

(57) ABSTRACT

A metal separator for a fuel cell of the present invention includes a metal substrate having a reactant flow pathway, and a metal nitride coating layer. The metal nitride coating layer covers the surface of the metal substrate on which a reactant flow pathway is formed and slurry-coated. A metal layer for improving adherence is formed between the surface of the metal substrate on which a reactant flow pathway is formed, and the electro-conductive metal nitride coating layer. The metal separator is suitable for a fuel cell since it is lightweight, and has excellent anti-corrosion and electric conductivity.

### CROSS-REFERENCE TO RELATED APPLICATION

This application claims priority to and the benefit of Korean Patent Application No. 10-2004-0097381 filed in the Korean Intellectual Property Office on Nov. 25, 2004, the entire content of which is incorporated herein by reference.

### FIELD OF THE INVENTION

The present invention relates to a metal separator and a method of preparing the same. More particularly, the present invention relates to a lightweight metal separator having excellent anti-corrosion and electro-conductivity and a method of preparing the same.

### BACKGROUND OF THE INVENTION

A fuel cell is a power generation system for producing electrical energy through the electrochemical redox reaction of an oxidant and a fuel such as hydrogen or a hydrocarbon-based material such as methanol, ethanol, natural gas, and the like.

Such fuel cells are a clean energy source capable of replacing fossil fuels. They include a stack composed of a unit cell and produce various ranges of power output. Since it has a four to ten times higher energy density than a small lithium battery, fuel cells are highlighted as a small portable power source.

Representative exemplary fuel cells include polymer electrolyte membrane fuel cells (PEMFC) and direct oxidation fuel cells (DOFC). The direct oxidation fuel cells include a direct methanol fuel cell which uses methanol as a fuel.

The polymer electrolyte fuel cells have advantages such as high energy and power output. However, they have problems in the need to carefully handle hydrogen gas and the requirement of accessory facilities such as a fuel reforming processor for reforming methane or methanol, natural gas, and the like in order to produce hydrogen as the fuel gas.

On the contrary, a direct oxidation fuel cell has a lower energy density than that of the polymer electrolyte fuel cell, but it has the advantages of the ease of handling the fuel, being capable of operating at room temperature due to its low operating temperature, and no need for additional fuel reforming processors.

In the above direct oxidation fuel cell, the stack that generates electricity substantially includes several to many unit cells stacked in multiple layers, and each unit cell is formed with a membrane-electrode assembly (MEA) and a separator (also referred to as a bipolar plate). The membrane-electrode assembly has an anode (also referred to as a fuel electrode or an oxidation electrode) and a cathode (also referred to as an air electrode or a reduction electrode) attached to each other with an electrolyte membrane between them.

A fuel is supplied to an anode and is adsorbed on catalysts, and the fuel is oxidized to produce protons and electrons. The electrons are transferred to a cathode via an out-circuit, and the protons are transferred to a cathode through a polymer electrolyte membrane. An oxidant is supplied to a cathode, and the oxidant, protons, and electrons are reacted on a catalyst at a cathode to produce electricity along with water.

The separators not only work as passageways for supplying the fuel required for the reaction to the anode and for supplying oxygen to the cathode, but also as current collectors. Since they can prevent explosions or combustion due to direct contact between the fuel and oxidant, they should have low gas permeability and good electro-conductivity.

Currently, graphite is usually used for a separator material, particularly a composite material which is made by pulverizing graphite through a mechanical grinding process to produce micrometer-sized particles and mixing them with a polymer resin.

In the prior art, large amounts by weight percentage of graphite should be used in order to obtain appropriate electro-conductivity, and processes such as those using agitating and molding are difficult because of an increase of the weight and viscosity of the separator materials. Strength, durableness, or stability of the resultant separator composite material cannot be obtained at an appropriate level.

In order to resolve such problems, research has been devoted to a metal separator that can replace a graphite separator. The metal separator has advantages in that an etching process can be preformed, costs can be saved, and excellent strength can be realized. However, a separator made of a metal or an alloy-based material may corrode under carbon monoxide, oxygen, and various acidic atmospheres to form an oxide film resulting in deterioration of the fuel cell performance.

### SUMMARY OF THE INVENTION

An exemplary embodiment of the present invention provides a metal separator for a fuel cell having excellent anti-corrosion and electro-conductivity properties.

Another embodiment of the present invention provides a method of preparing the metal separator for a fuel cell.

Yet another embodiment of the present invention provides a stack for a fuel cell which includes the metal separator.

According to an embodiment of the present invention, a metal separator for a fuel cell is provided which includes a metal substrate having a reactant flow pathway and a metal nitride coating layer. The metal nitride coating layer covers the surface of the metal substrate on which a reactant flow pathway is formed, and is slurry-coated thereon. A metal layer for improving adherence is formed between the surface of the metal substrate on which a reactant flow pathway is formed and the electro-conductive metal nitride coating layer.

According to another embodiment of the present invention, a metal separator a reactant flow pathway for a fuel cell is provided which includes a mixture of an electro-conductive metal nitride and a metal.

According to yet another embodiment of the present invention, a method for preparing a metal separator is provided which includes slurry coating an electro-conductive metal nitride on the surface of the metal separator on which a reactant flow pathway is formed.

According to still another embodiment of the present invention, a method for preparing a metal separator of the present invention includes mixing an electro-conductive metal nitride and a metal powder in a solvent, in which a binder is dissolved, to prepare a slurry for making a separator, pouring the slurry into the mold followed by drying, and molding the dried separator.

According to a still further embodiment of the present invention, a fuel cell stack is provided which includes a membrane-electrode assembly and metal separators positioned at each side of the membrane-electrode assembly. The membrane-electrode assembly includes a polymer electrolyte membrane and electrodes positioned at each side of the polymer electrolyte membrane.

### BRIEF DESCRIPTION OF THE DRAWINGS

FIG. 1 is a schematic cross-sectional view showing a metal separator for a fuel cell according to an embodiment of the present invention.

FIG. 2 is a schematic cross-sectional view showing a metal separator for a fuel cell according to another embodiment which includes a metal layer for improving adherence.

FIG. 3 is a schematic cross-sectional view showing a metal separator for a fuel cell according to an additional embodiment the present invention.

FIG. 4 is an exploded perspective view showing a fuel cell stack according to an embodiment of the present invention.

FIG. 5 is a graph showing voltage characteristics of fuel cells according to Example 1 and Comparative Example 1 versus operation time.

### DETAILED DESCRIPTION OF THE INVENTION

An embodiment of the present invention will hereinafter be described in detail with reference to the accompanying drawings.

The present invention includes metal separators according to the embodiments described below.

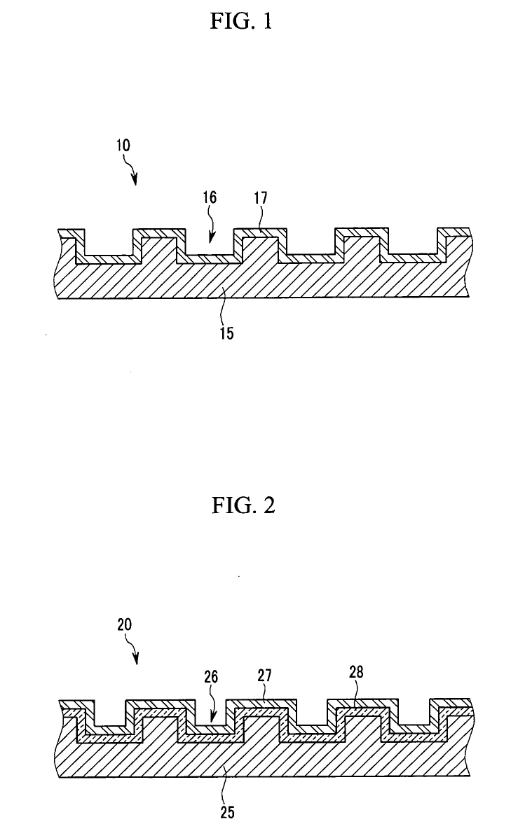

FIG. 1 is a schematic cross-sectional view showing a metal separator for a fuel cell according to an embodiment of the present invention. As shown in FIG. 1, a metal separator 10 according to an embodiment of the present invention includes a metal substrate 15 having reactant flow pathways 16 and a metal nitride coating layer 17. The metal nitride coating layer 17 covers the surface of the metal substrate 15 on which a reactant flow pathway 16 is formed, and is slurry-coated thereon. The metal nitride coating layer may have an average thickness ranging from 0.1 to 100 μm. When the thickness of the coating layer is less than 0.1 μm, the anti-corrosion effect is not sufficient, and when it is more than 100 μm, there are no further advantages as the thickness increases.

FIG. 2 is a schematic cross-sectional view showing a metal separator for a fuel cell according to another embodiment of the present invention. As shown in FIG. 2, a metal separator 20 according to the embodiment has the same structure as that of the above embodiment except including a metal layer 28 for improving adherence between the electro-conductive metal nitride coating layer 27 and the surface of a metal substrate 25 on which a reactant flow pathway 26 is formed.

The metal layer 28 for improving adherence may have an average thickness ranging from 10 Å to 10,000 Å. When the average thickness of the metal layer 28 is less than 10 Å, adherence is not sufficiently improved and when it is more than 10,000 Å, adherence does not increase further as the thickness increases.

Metals which may be used in metal layer 28 for improving adherence may include metals selected from the group consisting of titanium, cobalt, nickel, molybdenum, chromium, alloys thereof, and mixtures thereof. One embodiment of the present invention uses chromium. Since chromium oxide has better electrical conductivity compared to other metal oxides, there are advantages in that contact force increases and electrical conductivity cannot be deteriorated even though an oxide is formed.

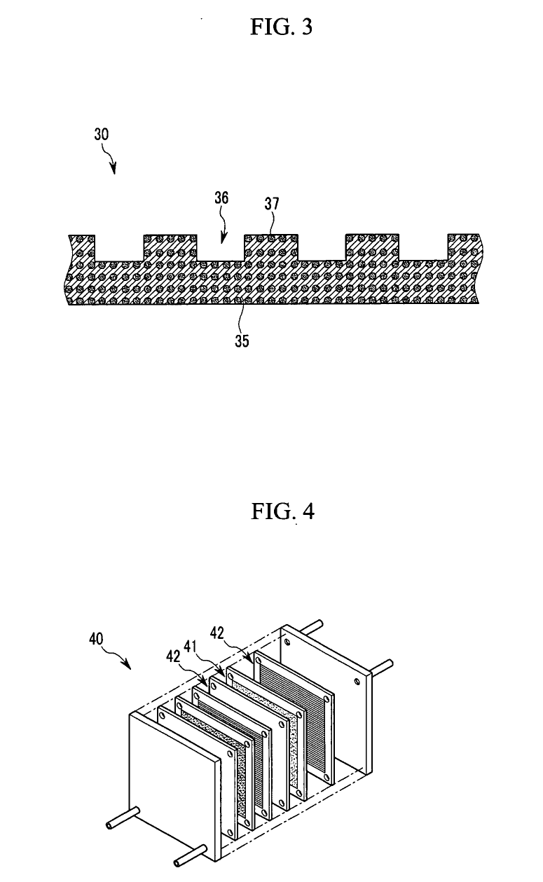

FIG. 3 is a schematic cross-sectional view showing a metal separator according to an additional embodiment of the present invention. As shown in FIG. 3, a metal separator 30 includes a mixture of electro-conductive metal nitride 37 and metals 35. Reactant flow pathways 36 are formed on the surface of the metal separator. The electro-conductive metal nitride 37 and the metals 35 may be mixed in a weight ratio ranging from 20:80 to 80:20. When the weight ratio of the metal nitride is less than 20, anti-corrosion decreases, and when it is more than 80, electrical conductivity may be deteriorated.

In the embodiments shown in FIGS. 1 and 3, the resultant reactant flow pathways may be formed in various shapes as needed. In an embodiment of the present invention, their depth is less than or equal to 2000 μm, and their width is less than or equal to 3000 μm. More preferably, the depth ranges from 400 to 1000 μm, and the width ranges from 500 to 1500 μm. When the depth is more than 2000 μm or the width is more than 3000 μm, it is difficult to down-size the fuel cell including the separator.

The electro-conductive metal nitride used in the metal separator has excellent anti-corrosion and electric conductivity properties.

In an embodiment of the present invention, the metal nitride has a corrosion value of less than or equal to 16 μA/cm², more preferably less than or equal to 10 μA/cm², and even more preferably 0 μA/cm². The corrosion value represents a current flow amount which occurs during metal corrosion. When the corrosion value is 0 μA/cm², a metal is not corroded. When the value is more than 16 μA/cm², electrical conductivity may be reduced.

In an embodiment of the present invention, the metal nitride may have electrical conductivity greater than or equal to 100 S/cm, preferably greater than or equal to 200 S/cm, and more preferably ranging from 200 S/cm to 10⁵ S/cm. When the metal nitride has electrical conductivity of less than 100 S/cm, it cannot perform as a metal separator for a fuel cell.

Metal nitrides having the above properties may include metals which are generally used for metal separators in fuel cells. Non-limiting examples of the metals include metals selected from the group consisting of aluminum, titanium, niobium, chromium, tin, molybdenum, zinc, zirconium, vanadium, hafnium, tantalum, tungsten, indium, stainless steel, and alloys thereof, and mixtures thereof. More preferably, the metal nitride may be selected from the group consisting of titanium nitride (TiN), titanium boron nitride (TiₘBₙN: m=0.5 to 0.75, n=0.25 to 0.5)), and titanium aluminum nitride (TiₓAl_{y}N: x=0.5 to 0.75, y=0.25 to 0.5), and mixtures thereof.

The metal substrates may also include metals generally used for metal separators in fuel cells. Non-limiting examples of the metals include those selected from the group consisting of aluminum, titanium, niobium, chromium, tin, molybdenum, zinc, zirconium, vanadium, hafnium, tantalum, tungsten, indium, stainless steel, alloys thereof, and mixtures thereof.

A metal separator according to an embodiment of the present invention may be fabricated by slurry coating an electro-conductive metal nitride on a surface of a metal substrate on which a reactant flow pathway is formed.

The electro-conductive metal nitride layer has an average thickness ranging from 0.1 to 100 μm. When the thickness of the electro-conductive metal nitride layer is less than 0.1 μm, the anti-corrosion effect is not sufficient, and when it is more than 100 μm, there are no further advantages as the thickness increases.

The metal nitride may be coated using general slurry coating methods such as spin coating, spray coating, or wash coat methods. Slurry coating uses well-known techniques which are not described in detail.

A metal separator according to another embodiment may be fabricated by forming a metal layer before the slurry coating of the metal nitride layer in order to improve adherence between the metal nitride coating layer and the metal substrate. The metal layer for improving adherence is formed using general vacuum deposition or slurry coating techniques such as spin coating, spray coating, or wash coat methods. The metal layer has an average thickness ranging from 10 Å to 10,000 Å. When the thickness is less than 10 Å, adherence is not sufficient, and when it is more than 10,000 Å, adherence does not further increase.

Metal layers for improving adherence may include metals selected from the group consisting of titanium, cobalt, nickel, molybdenum, and chromium, and alloys thereof, and mixtures thereof. An embodiment of the present invention uses chromium.

A metal separator according to the a further embodiment may be fabricated by the following processes: an electro-conductive metal nitride and a metal powder are mixed in an organic solvent, including a binder dissolved therein, to prepare a slurry, and the slurry is poured into a mold and dried to form a separator.

The electro-conductive metal nitride and the metal powder may be mixed in a weight ratio ranging from 20:80 to 80:20. The organic solvent and binder may be those which are generally used for preparing a slurry, and are not particularly limited.

The electro-conductive metal nitrides used in the metal separator according to the present invention have excellent anti-corrosion and electric conductivity properties.

In an embodiment of the present invention, the metal nitrides have a corrosion value of less than or equal to 16 μA/cm², preferably less than or equal to 10 μA/cm², and more preferably 0 μA/cm². The corrosion value represents a current flow amount which occurs during metal corrosion. When the corrosion value is 0 μA/cm², a metal is not corroded. When the value is more than 16 μA/cm², electrical conductivity may be reduced.

In an embodiment of the present invention, the metal nitride may have electrical conductivity greater than or equal to 100 S/cm, preferably greater than or equal to 200 S/cm, and more preferably ranging from 200 S/cm to 10⁵ S/cm. When the metal nitride has electrical conductivity of less than 100 S/cm, it cannot perform as a metal separator for a fuel cell.

Metal nitrides having the above properties may include metals which are generally used for metal separators in fuel cells. Non-limiting examples of the metals include metals selected from the group consisting of aluminum, titanium, niobium, chromium, tin, molybdenum, zinc, zirconium, vanadium, hafnium, tantalum, tungsten, indium, stainless steel, alloys thereof, and mixtures thereof. More preferably, the metal nitride may be selected from the group consisting of titanium nitride (TiN), titanium boron nitride (TiₘBₙN: m=0.5 to 0.75, n=0.25 to 0.5)), and titanium aluminum nitride (TiₓAl_{y}N: x=0.5 to 0.75, y=0.25 to 0.5), and mixtures thereof.

The metal substrates or metal powders according to the invention may also include metals generally used for metal separators in fuel cells. Non-limiting examples of the metals include those selected from the group consisting of aluminum, titanium, niobium, chromium, tin, molybdenum, zinc, zirconium, vanadium, hafnium, tantalum, tungsten, indium, stainless steel, alloys thereof, and mixtures thereof.

The metal separator for a fuel cell may be applied to various fuel cells such as a polymer electrolyte fuel cell (PEMFC) or a direct oxidation fuel cell (DOFC).

FIG. 4 is an exploded perspective view showing a fuel cell stack according to an embodiment of the present invention, and the stack illustrated in FIG. 4 is not limited to the structure illustrated in FIG. 4.

Referring to FIG. 4, a fuel cell stack 40 includes a membrane-electrode assembly 41, and separators 42 positioned at each side of the membrane-electrode assembly, which includes a polymer electrolyte membrane and electrodes positioned at each side of the polymer electrolyte membrane.

The membrane-electrode assembly (MEA) 41 performs the oxidation/reduction of hydrogen in a fuel and oxygen in air to generate electricity, and the separator supplies the fuel and air to the membrane-electrode assembly.

The membrane-electrode assembly includes an electrolyte membrane, a cathode catalyst layer at one face of the electrolyte membrane, an anode catalyst layer at the other face of the electrolyte membrane, and diffusion layers (DL) positioned on an outer surface of the cathode catalyst layer and anode catalyst layer. It may also include a microporous layer (MPL) between the cathode catalyst layer or anode catalyst layer, and the diffusion layer, as needed.

The membrane-electrode assembly includes an electrolyte membrane interposed between the anode and cathode catalyst layers.

A fuel is supplied to the anode through a separator. The anode includes a catalyst layer for producing electrons and protons by oxidation of the fuel, and a diffusion layer (DL) for transferring the fuel smoothly.

An oxidant is supplied to the cathode through a separator. The cathode includes a catalyst layer for producing water by reduction of the oxidant, and a diffusion layer for transferring the oxidants smoothly. The electrolyte membrane has a thickness ranging from 50 to 200 μm and plays the ion exchange role of transferring protons produced at the anode catalyst layer to the cathode catalyst layer.

The separator plays the role of a conductor connecting the anode and cathode of the membrane-electrode assembly in series. The separator works as passageways for supplying the fuel and oxidant required for the oxidation/reduction reaction to the membrane-electrode assembly. For this purpose, reactant flow pathways for supplying reactants required for the oxidation/reduction reaction of the membrane-electrode assembly are formed on a surface of the separator.

The separator is disposed at each side of the membrane-electrode assembly and is closely adjacent to an anode and a cathode of the membrane-electrode assembly.

The following examples illustrate the present invention in more detail. However, it is understood that the present invention is not limited by these examples.

### EXAMPLES

### Example 1

(Metal Separator for a Fuel Cell Which Includes a Coating Layer Formed Using a Titanium Nitride (TiN) Slurry)

A coating slurry including 3.5 g of polyvinylidene fluoride (PVdF), 481.5 g of N-methylpyrrolidone (NMP), and 50 g of TiN was coated on a surface having reactant flow pathways of a stainless steel 316L metal substrate and then dried to produce a metal separator having a 100 μm thick TiN coating layer.

A membrane-electrode assembly for a fuel cell was fabricated by positioning electrodes including platinum catalyst layers at each side of a poly (perfluorosulfonic acid) polymer electrolyte membrane, and then the metal separators were positioned at each side of the membrane-electrode assembly to assemble a fuel cell.

### Example 2

(Metal Separator for a Fuel Cell Which Includes a Coating Layer Formed Using Titanium Aluminum Nitride, TiₓAl_{y}N (x=0.6, y=0.4) Slurry)

A coating slurry including 3.5 g of polyvinylidene fluoride (PVdF), 481.5 g of N-methylpyrrolidone (NMP), and 50 g of Ti_{0.6}Al_{0.4}N was coated on a surface having reactant flow pathways of a stainless steel 316L metal substrate and then dried to produce a metal separator having a 100 μm thick Ti_{0.6}Al_{0.4}N coating layer.

A fuel cell was fabricated according to the same method as in Example 1 with the exception of using the above metal separator.

### Example 3

(Metal Separator for a Fuel Cell Which Includes a Coating Layer Formed Using TiN Slurry and a Metal Layer for Improving Adherence)

Chromium was coated using a sputtering method on a surface having reactant flow pathways composed of a stainless steel 316L metal substrate reactant flow pathways to form a 100 Å thick metal layer for improving adherence. A coating slurry including 3.5 g of polyvinylidene fluoride (PVdF), 481.5 g of N-methylpyrrolidone (NMP), and 50 g of TiN was coated on the metal layer for improving adherence formed on the stainless steel metal substrate, and then dried to produce a metal separator including a metal layer for improving adherence and a 100 μm thick TiN coating layer.

A fuel cell was fabricated according to the same method as in Example 1 with the exception of using the above metal separator.

### Example 4

(Metal Separator for a Fuel Cell Which Includes a Mixture of Titanium Nitride (TiN) and a Metal)

3.5 g of polyvinylidene fluoride (PVdF), 481.5 g of N-methylpyrrolidone (NMP), 50 g of TiN, and 50 g of a stainless steel powder were mixed to prepare a slurry for forming a metal separator. The slurry was poured into a mold having the shape of reactant flow pathways, and then dried to fabricate a metal separator including TiN and stainless steel.

A fuel cell was fabricated according to the same method as in Example 1 with the exception of using the above metal separator.

### Comparative Example 1

(Stainless Steel Separator for a Fuel Cell)

A fuel cell was fabricated according to the same method as in Example 1, except that a stainless steel 316L metal substrate having reactant flow pathways was used as a separator.

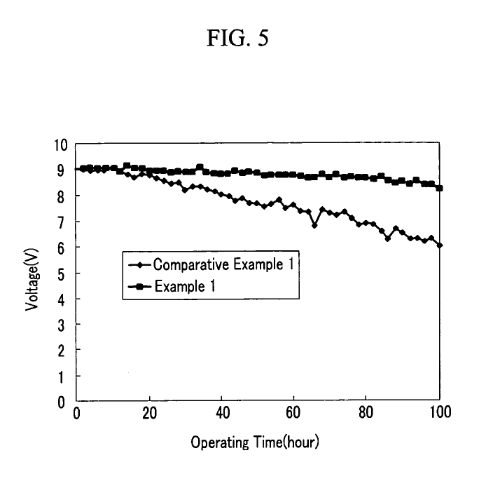

Fuel cells according to Example 1 and Comparative Example 1 were measured with respect to voltage characteristics of the cells over operating time. The results are shown in FIG. 5.

As shown in FIG. 5, the metal separator for a fuel cell according to Example 1 has good anti-corrosion and electric conductivity properties, and thereby can improve voltage characteristics with operating time.

While this invention has been described in connection with what are presently considered to be exemplary embodiments, it is to be understood that the invention is not limited to the disclosed embodiments, but, on the contrary, is intended to cover various modifications and equivalent arrangements included within the spirit and scope of the appended claims.

What is claimed is:

1. A separator for a fuel cell, comprising:
a metal substrate having a reactant flow pathway;
a metal nitride layer on the metal substrate; and
a metal layer between the surface of the metal substrate, and the electro-conductive metal nitride layer.

2. The separator of claim 1, wherein the metal nitride layer has an average thickness from 0.1 to 100 μm.

3. The separator of claim 1, wherein the metal layer has an average thickness from 10 Å to 10,000 Å.

4. The separator of claim 1, wherein the metal in the metal layer is selected from the group consisting of titanium, cobalt, nickel, molybdenum, chromium, alloys thereof, and combinations thereof.

5. The separator of claim 1, wherein the reactant flow pathway has a depth less than or equal to 2000 μm.

6. The separator of claim 1, wherein the reactant flow pathway has a depth from 400 to 1000 μm.

7. The separator of claim 1, wherein the reactant flow pathway has a width of less than or equal to 3000 μm.

8. The separator of claim 1, wherein the reactant flow pathway has a width from 500 to 1500 μm.

9. The separator of claim 1, wherein the metal nitride has electrical conductivity greater than or equal to 100 S/cm.

10. The separator of claim 1, wherein the metal nitride has a corrosion value less than or equal to 16 μA/cm².

11. The separator of claim 1, wherein the metal nitride is selected from the group consisting of titanium nitride (TiN), titanium boron nitride (TiₘBₙN) wherein m=0.5 to 0.75, n=0.25 to 0.5, titanium aluminum nitride (TiₓAl_{y}N) wherein x=0.5 to 0.75, y=0.25 to 0.5, and mixtures thereof.

12. The separator of claim 1, wherein the metal substrate is selected from the group consisting of aluminum, titanium, niobium, chromium, tin, molybdenum, zinc, stainless steel, alloys thereof, and mixtures thereof.

13. A separator for a fuel cell comprising a mixture of an electro-conductive metal nitride and a metal, and
a reactant flow pathway formed thereon.

14. The separator of claim 13, wherein the electro-conductive metal nitride and the metal are mixed in a weight ratio from 20:80 to 80:20.

15. The separator of claim 13, wherein the reactant flow pathway has a depth less than or equal to 2000 μm.

16. The separator of claim 13, wherein the reactant flow pathway has a depth from 400 to 1000 μm.

17. The separator of claim 13, wherein the reactant flow pathway has a width less than or equal to 3000 μm.

18. The separator of claim 13, wherein the reactant flow pathway has a width from 500 to 1500 μm.

19. The separator of claim 13, wherein the metal nitride has electrical conductivity greater than or equal to 100 S/cm.

20. The separator of claim 13, wherein the metal nitride has a corrosion value less than or equal to 16 μA/cm².

21. The separator of claim 13, wherein the metal nitride is selected from the group consisting of titanium nitride (TiN), titanium boron nitride (TiₘBₙN) wherein m=0.5 to 0.75, n=0.25 to 0.5, titanium aluminum nitride (TiₓAl_{y}N) wherein x=0.5 to 0.75, y=0.25 to 0.5, and mixtures thereof.

22. The separator of claim 13, wherein the metal is selected from the group consisting of aluminum, titanium, niobium, chromium, tin, molybdenum, zinc, stainless steel, alloys thereof, and combinations thereof.

23. A method for making a separator for a fuel cell comprising:
coating a metal layer on a metal substrate on which a reactant flow pathway is formed; and
coating an electro-conductive metal nitride on the metal layer.

24. The method of claim 23, wherein the metal layer is formed using a metal selected from the group consisting of titanium, cobalt, nickel, molybdenum, chromium, alloys thereof, and combinations thereof.

25. A method for making a separator for a fuel cell, comprising:
mixing an electro-conductive metal nitride and a metal powder in an organic solvent, including a binder dissolved therein, to prepare a slurry; and
pouring the slurry into a mold and drying it to form a separator.

26. The method of claim 25, wherein the electro-conductive metal nitride and the metal powder are mixed in a weight ratio from 20:80 to 80:20.
